(19) United States
(12) Patent Application Publication
(10) Pub. No.: US 2017/0266639 A1
(43) Pub. Date: Sep. 21, 2017

(54) GRAPHENE-CONTAINING NANOCOMPOSITE MATERIALS FOR SEQUESTRATION OF CARBON DIOXIDE

(71) Applicant: VAON, LLC, Bowling Green, KY (US)

(72) Inventor: Alber Sadek, Columbus, OH (US)

(21) Appl. No.: 15/459,826

(22) Filed: Mar. 15, 2017

Related U.S. Application Data
(60) Provisional application No. 62/308,782, filed on Mar. 15, 2016.

(51) Int. Cl. B01J 20/20; B01J 20/06; B01D 69/12; B01D 53/02; B01D 53/22; B01D 71/02; B01J 20/04; B01J 20/30

(52) U.S. Cl. CPC B01J 20/205; B01J 20/043; B01J 20/06; B01J 20/30; B01D 53/02; B01D 53/22; B01D 71/021; B01D 69/12; B01D 2253/102; B01D 2257/504; B01D 2053/221

(57) ABSTRACT

The present invention generally relates to CO₂-adsorbing, graphene-containing nanocomposites, methods of making the same, and methods of using the same.

### FIELD OF THE INVENTION

The present invention generally relates to CO₂-adsorbing, graphene-containing nanocomposites, methods of making the same, and methods of using the same.

### BACKGROUND OF THE INVENTION

There is a current focus on sequestering carbon dioxide (CO₂), particularly CO₂ produced during energy production (e.g., from coal-burning power plants). Before CO₂ can be sequestrated, it must be separated and captured from its source. Carbon capture and storage (CCS) technologies are a promising route for mitigating CO₂ emissions in the near future, because CCS could provide a mid-term solution allowing humanity to continue using fossil energy until renewable energy technologies mature. No unique solution exists currently to solve the problem of CO₂ capture, and this complex challenge will almost certainly require the integration of several technology options.

The selectivity of a separation process is determined by a combination of adsorption and diffusion selectivity, which are coupled in most materials. For example, the introduction of a functional group, that specifically binds one species and improves the adsorption selectivity, will simultaneously decrease the diffusion of these molecules. This inverse relationship between the adsorption and diffusion selectivity has recently been investigated extensively in a broad range of meso- and microporous materials including zeolites, carbon nanotubes, carbon molecular sieves, and metal-organic frameworks. The need therefore exists to design materials in which one can independently tune the diffusion and adsorption selectivity at the molecular level.

Layered double hydroxides (LDHs) have received attention because of their wide range of applications (e.g., catalysts, super capacitors, pharmaceuticals, photochemistry, electrochemistry, and adsorbents). LDHs, also known as hydrotalcite-like compounds, have also been considered as promising materials for CO₂ adsorption. The general formula of LDHs is:

[M²⁺₁₋ₓN³⁺ₓ(HO⁻)₂]^{x+}[Y^{m-}_{x/m}]nH₂O
M is a divalent cation, examples of which include Ca²⁺, CO²⁺, CU²⁺, Fe²⁺, Mg²⁺, Mn²⁺,
Ni²⁺, and Zn²⁺.
N is a trivalent cation, examples of which include Al³⁺, Fe³⁺, or Cr³⁺.
Y⁻ is an intercalating anion, examples of which include CO₃²⁻, SO₄²⁻, NO₃⁻, Cl⁻, and OH⁻.
x typically varies between 0.17 and 0.33, but there is no strict limitation to this value.
n typically varies between 0.5 and 4.
   An LDH is typically composed of positively charged M²⁺(OH)₂ layers in which divalent cations, octahedrally coordinated by hydroxyls, are partially substituted by trivalent cations resulting in positively charged layers with charge-balancing anions (A^{m-}) between them.

Previous CO₂ adsorption studies of an Mg—Al—CO₃ LDH reported an adsorption capacity of 0.5 mmol/g at 300° C. and 1 bar. (See Z. Yong, et al., Energy Consery Mgmt. 2002, 43, 1865-1876; and, Z. Yong et al., Ind. Eng. Chem. Res. 2001, Vol. 40, 204-209.) Improvements in performance are still required for practical applications.

One of the recent approaches to increase CO₂ adsorption capability of LDHs is to support them on oxidized multi-walled carbon nanotubes (MWNTs) or graphene oxide (GO). The reported synthesis method of the nano-composite material is based on in situ co-precipitation of LDH onto either MWNTs or GO in aqueous dispersion followed by thermal treatment at 60° F. for 12 h under magnetic stirring (300 rpm). (See S. Miyata et al., Clays Clay Miner. 1978, 26(6), 441-447; M. K. Ram Reddy et al., Ind. Eng. Chem. Res. 2006, 45, 7504-7509; and, Q. Wang et al., Applied Clay Science, 2012, 55, 18-26.)

In view of the above, it would be advantageous to discover CO₂-adsorbing, graphene-containing nanocomposites, and develop methods of making and using the same.

### SUMMARY OF THE INVENTION

In an aspect, the present invention provides novel, graphene-containing nanocomposites.

In another aspect, the present invention provides novel, graphene-containing layered double hydroxides.

In another aspect, the present invention provides a novel method of making graphene-containing nanocomposites.

In another aspect, the present invention provides a novel method of making graphene-containing layered double hydroxides.

In another aspect, the present invention provides use of novel, graphene-containing nanocomposites to adsorb CO₂.

In another aspect, the present invention provides use of novel, graphene-containing layered double hydroxides to adsorb CO₂.

These and other aspects, which will become apparent during the following detailed description, have been achieved by the inventors' discovery of graphene-containing nanocomposites.

### BRIEF DESCRIPTION OF THE DRAWINGS

FIG. 1 shows the Raman spectra (Intensity a.u./Raman shift cm⁻¹) for the Mg—Al-GNP nanocomposites of the present invention.

FIG. 2 shows the Raman spectra (Intensity a.u./Raman shift cm⁻¹) for the Ca—Al-GNP nanocomposites of the present invention.

FIG. 3 shows the Raman spectra (Intensity a.u./Raman shift cm⁻¹) for the Mg—Al-GO nanocomposites of the present invention.

FIG. 4 shows the Raman spectra (Intensity a.u./Raman shift cm⁻¹) for the TiO₂-GNP nanocomposites of the present invention.

### DETAILED DESCRIPTION OF THE PREFERRED ASPECTS

In an aspect, the present invention provides a novel graphene containing nanocomposite, comprising:
a. graphene; and,
b. a layered double hydroxide (LDH)), the LDH, comprising:
   (i) at least one divalent cation;
   (ii) at least one trivalent cation; and,
   (iii) at least one interlayer anion;
      wherein the graphene and LDH form a graphene-LDH nanocomposite (G-LDH).

In another aspect, there are at least two interlayer anions in the LDH.

In another aspect, the molar ratio of divalent cation to trivalent cation is 2:1.

In another aspect, the LDH, comprises:
(i) one divalent cation;
(ii) one trivalent cation; and,
(iii) first and second interlayer anions.

In another aspect, the molar ratio of divalent cation to trivalent cation is 2:1.

In another aspect, the graphene is selected from: graphene nano platelets (GNP), GNP-oxide (GNP-O), graphene oxide (GO), GNP-nitrogen (GNP-N₂), GNP-amine (GNP-NH₂), and GNP-silicon (GNP-Si). These types of graphene are commercially available from Cheap Tubes and other graphene vendors.

In another aspect, in the nanocomposite:
the at least one divalent cation is selected from: Mg²⁺, Ni²⁺, Zn²⁺, Ca²⁺, Cu²⁺, and Mn²⁺;
the at least one trivalent cation is selected from: Al³⁺and Fe³⁺; and,
the at least one interlayer anion is selected from: CO₃²⁻, SO₄²⁻, NO₃⁻, and Cl⁻.

In another aspect, the divalent and trivalent cations are Mg²⁺ and Al³⁺, respectively.

In another aspect, the divalent and trivalent cations are Ca²⁺ and Al³⁺, respectively.

In another aspect, the divalent and trivalent cations are Mg²⁺ and Fe³⁺, respectively.

In another aspect, the interlayer anion is selected from: CO₃²⁻ and NO₃⁻.

In another aspect, there are two interlayer anions, which are CO₃²⁻ and NO₃⁻.

In another aspect, the nanocomposite is selected from A-X:

| | | Divalent | Trivalent |
|---|---|---|---|
| G-LDH # | Graphene | Cation | Cation |
| A. | GNP | Mg²⁺ | Al³⁺ |
| B. | GNP | Ca²⁺ | Al³⁺ |
| C. | GNP | Mg²⁺ | Fe³⁺ |
| D. | GNP | Mn²⁺ | Fe³⁺ |
| E. | GNP-O | Mg²⁺ | Al³⁺ |
| F. | GNP-O | Ca²⁺ | Al³⁺ |
| G. | GNP-O | Mg²⁺ | Fe³⁺ |
| H. | GNP-O | Mn²⁺ | Fe³⁺ |
| I. | GO | Mg²⁺ | Al³⁺ |
| J. | GO | Ca²⁺ | Al³⁺ |
| K. | GO | Mg²⁺ | Fe³⁺ |
| L. | GO | Mn²⁺ | Fe³⁺ |
| M. | GNP-N₂ | Mg²⁺ | Al³⁺ |
| N. | GNP-N₂ | Ca²⁺ | Al³⁺ |
| O. | GNP-N₂ | Mg²⁺ | Fe³⁺ |
| P. | GNP-N₂ | Mn²⁺ | Fe³⁺ |
| Q. | GNP-NH₂ | Mg²⁺ | Al³⁺ |
| R. | GNP-NH₂ | Ca²⁺ | Al³⁺ |
| S. | GNP-NH₂ | Mg²⁺ | Fe³⁺ |
| T. | GNP-NH₂ | Mn²⁺ | Fe³⁺ |
| U. | GNP-Si | Mg²⁺ | Al³⁺ |
| V. | GNP-Si | Ca²⁺ | Al³⁺ |
| W. | GNP-Si | Mg²⁺ | Fe³⁺ |
| X. | GNP-Si | Mn²⁺ | Fe³⁺ |

wherein the molar ratio of divalent cation to trivalent cation is 2:1.

In another aspect, the molar ratio of divalent cation to trivalent cation is 2:1 and the weight (mg)/mmol ratio of graphene to divalent cation is about 3.5 to 214.

In another aspect, the molar ratio of divalent cation to trivalent cation is 2:1 and the weight (mg)/mmol ratio of graphene to divalent cation is selected from: (a) 3.5 to 179, (b) 7.1 to 143, (c) 8.9 to 107, and (d) 8.9 to 71.4.

In another aspect, the present invention provides a novel process of preparing a graphene containing layered double hydroxide (G-LDH), comprising:
a. mixing an aqueous LDH-containing solution and graphene; and,
b. sonicating the resulting mixture to form a G-LDH;
   the LDH, comprises:
(i) at least one divalent cation;
(ii) at least one trivalent cation; and,
(iii) at least one interlayer anion;
   wherein the molar ratio of divalent to trivalent cation is 2:1.

In another aspect, the LDH, comprises: at least two interlayer anions.

In another aspect, in the process:
the at least one divalent cation is selected from: Mg²⁺Ni²⁺, Zn²⁺, Ca²⁺, Cu²⁺, and Mn²⁺;
the at least one trivalent cation is selected from: Al³⁺ and Fe³⁺; and,
the at least one interlayer anion is selected from: CO₃²⁻, SO₄²⁻, NO₃⁻, and Cr.

In another aspect, the divalent and trivalent cations are Mg²⁺ and Al³⁺, respectively.

In another aspect, the divalent and trivalent cations are Ca²⁺ and Al³⁺, respectively.

In another aspect, the divalent and trivalent cations are Mg²⁺ and Fe³⁺, respectively.

In another aspect, the interlayer anion is selected from: CO₃²⁻ and NO₃⁻.

In another aspect, there are two interlayer anions, which are CO₃²⁻ and NO₃⁻.

In another aspect, the G-LDH formed is selected from A-X:

| | | Divalent | Trivalent |
|---|---|---|---|
| G-LDH # | Graphene | Cation | Cation |
| A. | GNP | Mg²⁺ | Al³⁺ |
| B. | GNP | Ca²⁺ | Al³⁺ |
| C. | GNP | Mg²⁺ | Fe³⁺ |
| D. | GNP | Mn²⁺ | Fe³⁺ |
| E. | GNP-O | Mg²⁺ | Al³⁺ |
| F. | GNP-O | Ca²⁺ | Al³⁺ |
| G. | GNP-O | Mg²⁺ | Fe³⁺ |
| H. | GNP-O | Mn²⁺ | Fe³⁺ |
| I. | GO | Mg²⁺ | Al³⁺ |
| J. | GO | Ca²⁺ | Al³⁺ |
| K. | GO | Mg²⁺ | Fe³⁺ |
| L. | GO | Mn²⁺ | Fe³⁺ |
| M. | GNP-N₂ | Mg²⁺ | Al³⁺ |
| N. | GNP-N₂ | Ca²⁺ | Al³⁺ |
| O. | GNP-N₂ | Mg²⁺ | Fe³⁺ |
| P. | GNP-N₂ | Mn²⁺ | Fe³⁺ |
| Q. | GNP-NH₂ | Mg²⁺ | Al³⁺ |
| R. | GNP-NH₂ | Ca²⁺ | Al³⁺ |
| S. | GNP-NH₂ | Mg²⁺ | Fe³⁺ |
| T. | GNP-NH₂ | Mn²⁺ | Fe³⁺ |
| U. | GNP-Si | Mg²⁺ | Al³⁺ |
| V. | GNP-Si | Ca²⁺ | Al³⁺ |
| W. | GNP-Si | Mg²⁺ | Fe³⁺ |
| X. | GNP-Si | Mn²⁺ | Fe³⁺. |

In another aspect, the weight (mg)/mmol ratio of graphene to divalent cation is about 3.5 to 214.

In another aspect, the weight (mg)/mmol ratio of graphene to divalent cation is selected from: (a) about 3.5 to 179, (b) about 7.1 to 143, (c) about 8.9 to 107, and (d) about 8.9 to 71.4.

In another aspect, the temperature of the mixture during sonication is from 50-80° C.

In another aspect, the temperature of the mixture during sonication is 60° C.

In another aspect, the sonication parameters are chosen to maintain a temperature of the mixture during sonication of from 50-80° C.

In another aspect, the sonication parameters are chosen to maintain a temperature of the mixture during sonication of 60° C.

In another aspect, water is also adding during the mixing.

In another aspect, the resulting G-LDH is washed with water.

In another aspect, the G-LDH is washed with water until the water has a pH of 7.

In another aspect, the LDH-containing solution is formed by mixing a salt solution with an aqueous solution, wherein:
the salt solution, comprises:
   a divalent cation; and,
   a trivalent cation; and,
the aqueous solution, comprises:
   a hydroxide; and,
   an interlayer anion.

In another aspect, the present invention provides a novel graphene containing nanocomposite, comprising:
a. graphene; and,
b. TiO₂;
   wherein the graphene and TiO₂ form a graphene-TiO₂ nanocomposite (G-TiO₂).

In another aspect, the weight (mg)/mmol ratio of graphene to Ti is about 0.6 to 35.5.

In another aspect, the weight (mg)/mmol ratio of graphene to Ti is selected from: (a) about 0.6 to 29.6, (b) about 1.2 to 23.7, (c) about 1.5 to 17.8, and (d) about 1.5 to 11.8.

In another aspect, the graphene is selected from: graphene nano platelets (GNP), GNP-oxide (GNP-O), graphene oxide (GO), GNP-nitrogen (GNP-N₂), GNP-amine (GNP-NH₂), and GNP-silicon (GNP-Si).

In another aspect, the present invention provides a novel process of preparing a graphene containing nanocomposite, comprising:
a. mixing a sol-gel solution and graphene; and,
b. sonicating the resulting mixture to form a G-TiO₂;
   wherein the sol-gel solution, comprises: a Ti(IV)-containing compound.

In another aspect, the weight (mg)/mmol ratio of graphene to Ti is about 0.6 to 35.5.

In another aspect, the weight (mg)/mmol ratio of graphene to Ti is selected from: (a) about 0.6 to 29.6, (b) about 1.2 to 23.7, (c) about 1.5 to 17.8, and (d) about 1.5 to 11.8.

In another aspect, the graphene is selected from: graphene nano platelets (GNP), GNP-oxide (GNP-O), graphene oxide (GO), GNP-nitrogen (GNP-N₂), GNP-amine (GNP-NH₂), and GNP-silicon (GNP-Si).

In another aspect, the sol-gel solution is formed by sonicating a mixture of a Ti(IV) tetra ester, an alcohol, and a base.

In another aspect, the resulting G-TiO₂ is heated to at least 350° C. for about an hour.

In another aspect, the resulting G-TiO₂ is heated to at least 400° C. for about an hour.

In another aspect, the resulting G-TiO₂ is heated to at least 450° C. for about an hour.

In another aspect, the molar ratio of divalent cation to trivalent cation is 2:1.

In another aspect, the weight (mg)/mmol ratio of graphene to divalent cation in the G-LDH is about 3.5 to 214. Additional examples of the weight (mg)/mmol ratio of graphene to divalent cation include about (a) 3.5 to 179, (b) 7.1 to 143, (c) 8.9 to 107, (d) 8.9 to 71.4, and (e) 8.9, 17.9, 26.8, 35.7, 44.6, 53.6, 62.5, and 71.4.

In another aspect, the weight (mg)/mmol ratio of graphene to Ti in the TiO₂-GNP is about 0.6 to 35.5. Additional examples of the weight (mg)/mmol ratio of graphene to divalent cation include about (a) 0.6 to 29.6, (b) 1.2 to 23.7, (c) 1.5 to 17.8, (d) 1.5 to 11.8, and (e) 1.5, 3, 4.4, 5.9, 7.4, 8.9, 10.4, and 11.8.

In another aspect, from 10-600 mg of graphene is present in the nanocomposite. Additional examples of the amount graphene present (or used in the present process) include: (a) 10-500, (b) 20-400, (c) 25-300, (d) 25-200, and (e) 25, 50, 75, 100, 125, 150, 175, and 200. Other examples include 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, and 600 mg.

### EXAMPLES

The following examples are meant to illustrate, not limit, the present invention.

### Example 1

### Preparation of Graphene Containing Layered Double Hydroxides (G-LDH)

An Mg—Al LDH mixture was prepared by mixing an aqueous salt solution of Mg²⁺ and Al³⁺ ions (with a molar ratio of 2:1) with an alkaline solution of NaOH and Na₂CO₃.

Aqueous salt solution: 1.4 mL total volume:
a. 2.8 mmol Mg(NO₃)₂.6 H₂O
b. 1.4 mmol Al(NO₃)₃.9 H₂O

Aqueous solution: 2.06 mL total volume:
a. 9.9 mmol NaOH
b. 2.5 mmol Na₂CO₃

To the LDH mixture was added distilled water (25 mL) and graphene nano platelets (GNP) (e.g., 25 mg) (purchased from Cheap Tubes, GNPs Grade 4). The resulting mixture was then sonicated. Pulse sonication was used under the following conditions
a. Sonication apparatus: QSONICA Model Q500
b. Amplitude: 15 KHz
c. Pulse cycle
(i) UT cycle: 10 sec.
(ii) Off cycle: 30 sec.
d. Total sonication time: 10 min.
e. Total time of the sonication process: 40 min.
   The chosen sonication conditions resulted in the temperature of the mixture being maintained around 60° C.

Once sonication was completed, the formed precipitates were washed with distilled water by placing the sonicated mixture in a vessel, adding distilled water, shaking, allowing the precipitates to settle, decanting off the water, and repeating until the pH of the added water was 7. After the pH reached 7, the precipitates were filtered off using a 0.4 μm polycarbonate membrane and dried in air at room temperature.

TABLE 1A
Mg—Al LDH

| LDH | GNP (mg) | | | | |
|---|---|---|---|---|---|
| Mg—Al | 25 | 50 | 100 | 300 | 600 |
| — | GNP-N₂¹ | | | | |
| Mg—Al | — | — | 100 | 300 | 600 |
| — | GNP-NH₂ | | | | |
| Mg—Al | — | — | 100 | 300 | 600 |
| — | GNP-Si | | | | |
| Mg—Al | — | — | 100 | 300 | 600 |

¹GNP-N₂ (GNPs grade 4 N₂ rich), GNP-NH₂ (GNPs grade 4 NH₂ rich), and GNP-Si (Si decorated GNPs) were each purchased from Cheap Tubes.

The Mg—AL LDH's in Table 1A were made according to the above procedure.

TABLE 1B
Ca—Al GNP-LDH

| LDH | GNP (mg) | | | | |
|---|---|---|---|---|---|
| Ca—Al | 25 | 50 | 100 | 300 | 600 |

The Ca-AL LDH's in Table 1B were made according to the above procedure with the exception that 2.8 mmol Ca(NO₃)₂.4 H₂O replaced 2.8 mmol Mg(NO₃)₂.6 H₂O in the salt solution.

TABLE 1C
GNP-Oxide-LDH, GO-LDH

| LDH | GNP Oxide (mg) | | | GO (mg) | | | | |
|---|---|---|---|---|---|---|---|---|
| Mg—Al | 50 | 75 | 100 | 50 | 75 | 100 | 120 | 150 |

The Mg-AL LDH's in Table 1C were made according to the above procedure with the exception that GNP was replaced by either GNP Oxide (made as described below) or GO (purchased as described below).

GNP Oxide:

A solution (14 mL) of concentrated H₂SO₄ and HNO₃ (3:1 ratio) was prepared. To the solution was added GNP (400 mg). The resulting mixture was stirred at 300 rpm and heated to reflux (80° C.) for 30 min. After cooling, the resulting oxidized GNP (GNP Oxide) was washed with distilled water and 0.01M NaOH until the wash solution reached pH 7. The GNP Oxide was collected on a 0.4 μm polycarbonate membrane.

GO (Graphene Oxide):

A GO dispersion in water (5 g/L) was purchased from Graphene Supermarket. This dispersion is used in place of the GNP/distilled water in the GNP-LDH process described above to prepare GO-LDH.

Characterization:

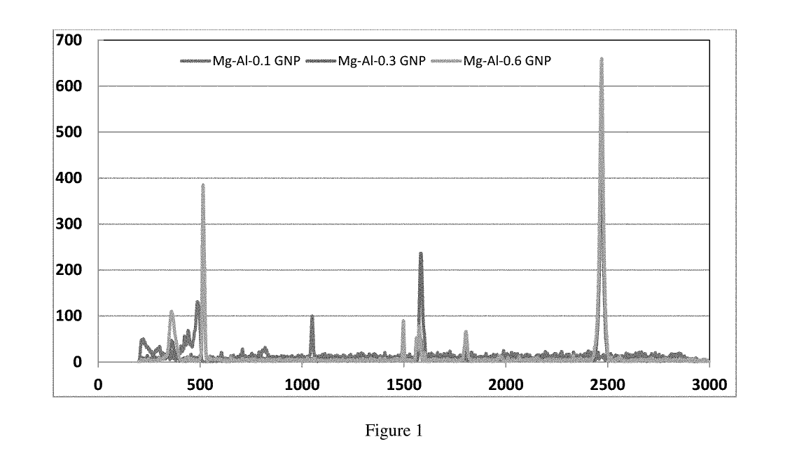

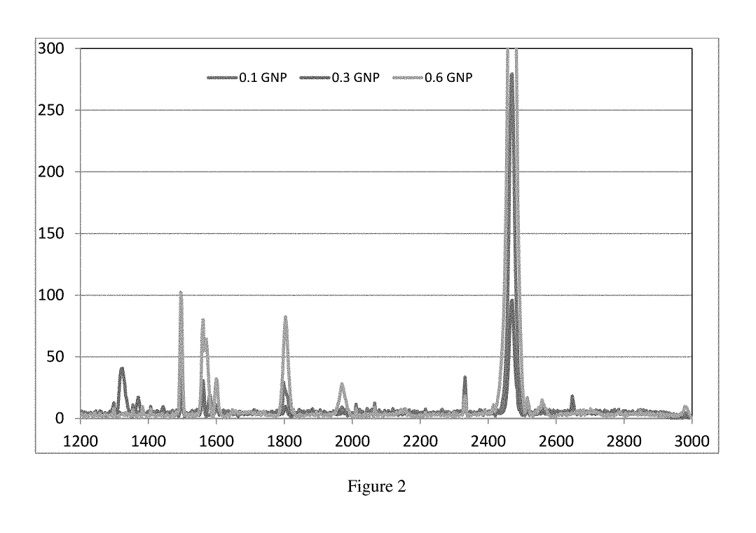

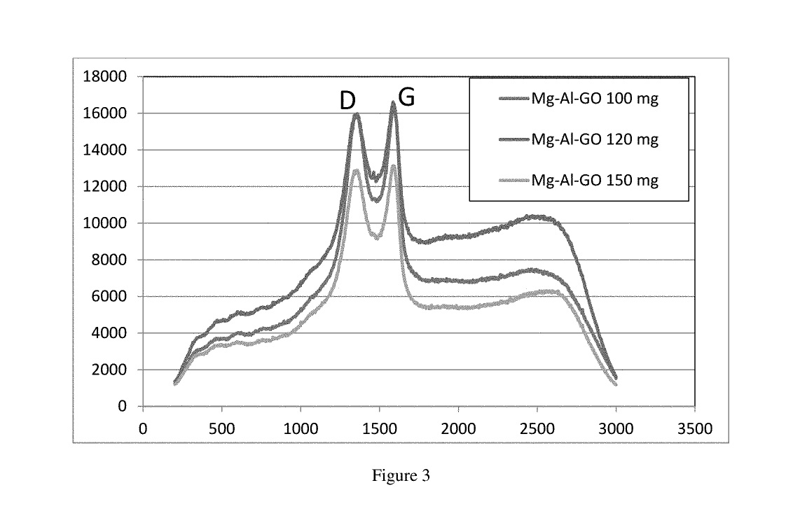

The products can be characterized by a number of different techniques, including transmission electron microscopy (TEM) imaging, scanning electron microscopy, energy dispersive X-ray spectrometry, and Raman. Raman analysis was performed by using Raman microscopy model IDR-Micro-532 and the results are shown in FIGS. 1-4.

The D/G peak ratios from the Raman analysis are shown in tables 1D-1F.

TABLE 1D
Mg—Al-GNP Raman Analysis

| | |
|---|---|
| Mg—Al-100 GNP | I_{D}/I_{G} = 0.38 |
| Mg—Al-300 GNP | I_{D}/I_{G} = 0.08 |
| Mg—Al-600 GNP | I_{D}/I_{G} = 0.03 |
| GNP | I_{D}/I_{G} = 0.03 |

TABLE 1D
Ca—Al-GNP Raman Analysis

| | |
|---|---|
| Ca—Al-0.1GNP | I_{D}/I_{G} = 0.24 |
| Ca—Al-0.3 GNP | I_{D}/I_{G} = 0.12 |
| Ca—Al-0.6 GNP | I_{D}/I_{G} = 0.04 |
| GNP | I_{D}/I_{G} = 0.03 |

TABLE 1D
Mg—Al-GNP Raman Analysis

| | |
|---|---|
| Mg—Al-GO 100 mg | I_{D}/I_{G} = 0.97 |
| Mg—Al-GO 120 mg | I_{D}/I_{G} = 0.96 |
| Mg—Al-GO 150 mg | I_{D}/I_{G} = 0.98 |

### Example 2

### Preparation of Graphene-Containing Titanium Nanocomposites (Ti-GNP)

Ti(O-i-Pr)₄ (97%) isopropyl alcohol, HNO₃, and distilled water in a volume ratio of 1:10:1:0.2, respectively (5 mL/50 mL/5 mL/1 mL)(16.9 mmol Ti)(total volume=61 mL), were mixed and sonicated (conditions below) to achieve a sol-gel solution. GNP (e.g., 100 mg) was mixed with the resulting sol-gel solution and the resulting mixture sonicated (conditions below). The resulting solution was filtered and dried in an oven at 80° C. followed by thermal treatment in air atmosphere at 450° C. for 1 h to achieve TiO₂-GNP with a uniform TiO₂ phase.
a. Sonication apparatus: QSONICA Model Q500
b. Amplitude: 15 KHz
c. Pulse cycle
(i) UT cycle: 15 sec.
(ii) Off cycle: 30 sec.
d. Total sonication time is 10 min.
e. Total time of the sonication process=45 min.

TABLE 2A
Ti-GNP

| | GNP (mg) | | |
|---|---|---|---|
| TiO₂ | 100 | 300 | 600 |

The Ti-GNP's in Table 2A were made according to the above procedure.

Characterization:

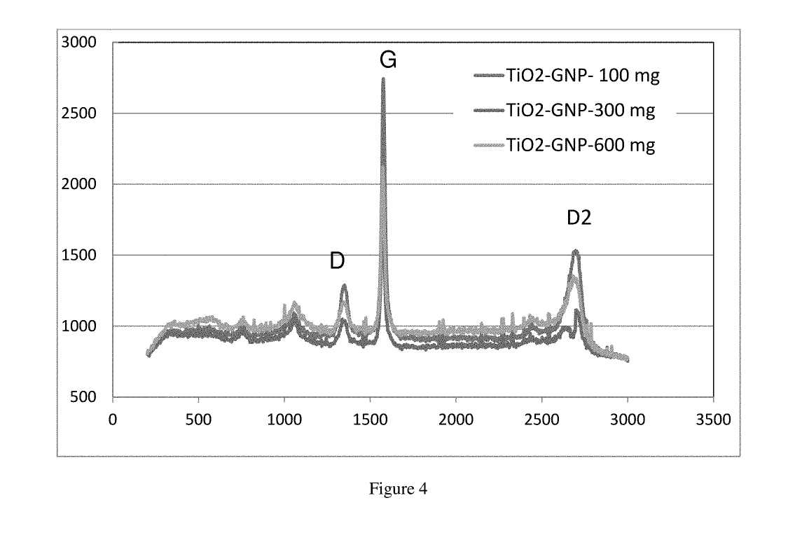

The titanium can be characterized as described above. Raman analysis was performed by using Raman microscopy model IDR-Micro-532 and the results are shown in FIG. 4.

The D/G peak ratios from the Raman analysis are shown in table 2D.

TABLE 2D
TiO₂-GNP Raman Analysis

| | |
|---|---|
| TiO₂-GNP-100 mg | I_{D}/I_{G} = 0.48 |
| TiO₂-GNP-300 mg | I_{D}/I_{G} = 0.59 |
| TiO₂-GNP-600 mg | I_{D}/I_{G} = 0.55 |

### Example 3

### Calcination

Calcination was carried as follows:
a. Test samples (e.g., GNP-LDH) were loaded into a horizontal tube furnace, followed by rough vacuum for 10 min.
b. Ultra-pure nitrogen gas was introduced into the tube furnace getting the tube chamber to positive pressure, followed by vacuum (100-200 torr) for 10 min.
c. The above cycle was repeated three times to assure that the environment inside the tube chamber was pure nitrogen.
d. The samples were then heated at 400° C. for 4 h under an ultra-pure nitrogen gas flow of 0.1 L/min.
e. The furnace was then cooled to room temperature under the continuous flow of nitrogen gas.
f. The resulting calcinated/activated products were stored in a sealed glass container.

### Example 4

4A: Adsorption Measurement:

A horizontal tube furnace was used to determine the adsorption capacity of pre-calcined samples, as follows:
a. An absorbent powder (25 mg) of the present invention, calcined as described in Example 2, was loaded in a furnace, followed by rough vacuum for 10 min.
b. Ultra-pure nitrogen gas flowed in the tube furnace getting the tube chamber to positive pressure, followed by vacuum again for 10 min. This cycle was repeated three times to assure that the environment inside the tube chamber is pure nitrogen.
c. The furnace was then heated to 400° C. for 1 h, in pure nitrogen with a flow rate of 0.07 L/min, to remove any CO₂ that could be captured from the atmosphere during its storage and transportation.
d. The temperature was then decreased to the required adsorption temperature (two adsorption temperatures were selected in this study, 300° C. and 100° C.), and the gas feed was switched to a 20% CO₂/80% N₂ premixed gas and held for 2 hours with gas flow rate of 0.06 L/min.
e. The furnace was then cooled to room temperature, while maintaining flow of the CO₂/N₂ gas mixture.
f. The adsorption capacity of the tested material was determined by measuring the change in mass before and after the adsorption test.

4B: Regeneration and Stability:

The regeneration and stability of the absorbent powders of the present invention was assessed by multi-cycle tests in which the adsorption step was carried out at 300° C. and/or 100° C. for 1 hour by flowing the premixed CO₂/N₂ gas and the desorption step was performed at 400° C. for 1 h by flowing nitrogen. The flow rates of both gases were kept constant during the experiment.

### Example 5

### Results of Adsorption and Recyclability Tests

TABLE 5
Summary of test data generated from testing described
in Example 4, using 20% CO₂ + N₂ gas.

| | | CO₂ Adsorbed |
|---|---|---|
| Material | CO₂ Adsorbed @100° C. | @300° C. |
| (mg G) | (mmol CO₂/g material) | (mmol/g) |
| Mg—Al-GNP | 0.90* | Not Measured (NM) |
| (25 mg) | | |
| Mg—Al-GNP | 0.69 | NM |
| (50 mg) | | |
| Mg—Al-GNP | 0.44 | NM |
| (75 mg) | | |
| Mg—Al-GNP | 0.38 | 0.86 |
| (100 mg) | | |
| Mg—Al-GNP | 0.05 | 0.34 |
| (300 mg) | | |
| Mg—Al-GNP | 0 | 0.00 |
| (600 mg) | | |
| Ca—Al-GNP | 0 | 0.01 |
| (25 mg) | | |
| Ca—Al-GNP | 0 | 0.01 |
| (50 mg) | | |
| Ca—Al-GNP | 0 | 0.01 |
| (75 mg) | | |
| Ca—Al-GNP | 0 | 0.03 |
| (100 mg) | | |
| Ca—Al-GNP | 0 | 0 |
| (300 mg) | | |
| Ca—Al-GNP | 0 | 0 |
| (600 mg) | | |
| Mg—Al-Oxidized GNP | 0.6 | NM |
| (50 mg) | | |
| Mg—Al-Oxidized GNP | 0.6 | NM |
| (75 mg) | | |
| Mg—Al-Oxidized GNP | 0.7* | NM |
| (100 mg) | | |
| Mg—Al-GO | 7 | NM |
| (50 mg) | | |
| Mg—Al-GO | 4.8 | NM |
| (75 mg) | | |
| Mg—Al-GO | 14-20 | NM |
| (100 mg) | | |
| Mg—Al-GO | 15.85 | NM |
| (120 mg) | | |
| Mg—Al-GO | 15.58 | NM |
| (150 mg) | | |
| TiO₂-GNP | 0.0 | 0.0 |
| (100 mg) | | |
| TiO₂-GNP | 1.3 | 1.2 |
| (300 mg) | | |
| TiO₂-GNP | 0.0 | 0.9 |
| (600 mg) | | |

*Good recyclability shown: amount of CO₂ adsorbed after 1^{st} adsorption/desorption cycle is ~90-95% of that adsorbed during 1^{st} run.

### Example 6

Additional examples of the present invention, which can be prepared as described above, are shown in Tables 6A-6F. The molar ratio of divalent to trivalent cation is 2:1, with 2.8 mmol of divalent cation being present in each example.

TABLE 6A

| LDH | GNP (mg) | | | | | | |
|---|---|---|---|---|---|---|---|
| Mg—Al | 25 | 50 | 75 | 100 | 150 | 300 | 600 |
| Ca—Al | 25 | 50 | 75 | 100 | 150 | 300 | 600 |
| Mg—Fe | 25 | 50 | 75 | 100 | 150 | 300 | 600 |
| Mn—Fe | 25 | 50 | 75 | 100 | 150 | 300 | 600 |

TABLE 6B

| LDH | GNP-Oxide (mg) | | | | | | |
|---|---|---|---|---|---|---|---|
| Mg—Al | 25 | 50 | 75 | 100 | 150 | 300 | 600 |
| Ca—Al | 25 | 50 | 75 | 100 | 150 | 300 | 600 |
| Mg—Fe | 25 | 50 | 75 | 100 | 150 | 300 | 600 |
| Mn—Fe | 25 | 50 | 75 | 100 | 150 | 300 | 600 |

TABLE 6C

| LDH | GO (mg) | | | | | | |
|---|---|---|---|---|---|---|---|
| Mg—Al | 25 | 50 | 75 | 100 | 150 | 300 | 600 |
| Ca—Al | 25 | 50 | 75 | 100 | 150 | 300 | 600 |
| Mg—Fe | 25 | 50 | 75 | 100 | 150 | 300 | 600 |
| Mn—Fe | 25 | 50 | 75 | 100 | 150 | 300 | 600 |

TABLE 6D

| LDH | GNP-N₂ (mg) | | | | | | |
|---|---|---|---|---|---|---|---|
| Mg—Al | 25 | 50 | 75 | 100 | 150 | 300 | 600 |
| Ca—Al | 25 | 50 | 75 | 100 | 150 | 300 | 600 |
| Mg—Fe | 25 | 50 | 75 | 100 | 150 | 300 | 600 |
| Mn—Fe | 25 | 50 | 75 | 100 | 150 | 300 | 600 |

TABLE 6E

| LDH | GNP-NH₂ (mg) | | | | | | |
|---|---|---|---|---|---|---|---|
| Mg—Al | 25 | 50 | 75 | 100 | 150 | 300 | 600 |
| Ca—Al | 25 | 50 | 75 | 100 | 150 | 300 | 600 |
| Mg—Fe | 25 | 50 | 75 | 100 | 150 | 300 | 600 |
| Mn—Fe | 25 | 50 | 75 | 100 | 150 | 300 | 600 |

TABLE 6F

| LDH | GNP-Si (mg) | | | | | | |
|---|---|---|---|---|---|---|---|
| Mg—Al | 25 | 50 | 75 | 100 | 150 | 300 | 600 |
| Ca—Al | 25 | 50 | 75 | 100 | 150 | 300 | 600 |
| Mg—Fe | 25 | 50 | 75 | 100 | 150 | 300 | 600 |
| Mn—Fe | 25 | 50 | 75 | 100 | 150 | 300 | 600 |

### Example 7

Additional TiO₂-GNP examples of the present invention, which can be prepared as described above, are shown below. 16.9 mmol of Ti is present in each example.

TABLE 7
TiO₂ materials

| Graphene Type | Graphene Weight (mg) | | | | | | |
|---|---|---|---|---|---|---|---|
| GNP | 25 | 50 | 75 | 100 | 150 | 300 | 600 |
| GNP-Oxide | 25 | 50 | 75 | 100 | 150 | 300 | 600 |
| GO | 25 | 50 | 75 | 100 | 150 | 300 | 600 |
| GNP-N₂ | 25 | 50 | 75 | 100 | 150 | 300 | 600 |
| GNP-NH₂ | 25 | 50 | 75 | 100 | 150 | 300 | 600 |
| GNP-Si | 25 | 50 | 75 | 100 | 150 | 300 | 600 |

Numerous modifications and variations of the present invention are possible in light of the above teachings. It is therefore to be understood that within the scope of the appended claims, the invention may be practiced otherwise that as specifically described herein.

We claim:

1. A graphene containing nanocomposite, comprising:
(a) graphene; and,
(b) a layered double hydroxide (LDH)), the LDH, comprising:
(i) at least one divalent cation;
(ii) at least one trivalent cation; and,
(iii) at least one interlayer anion;
wherein the graphene and LDH form a graphene-LDH nanocomposite (G-LDH).

2. The nanocomposite of claim 1, wherein there are at least two interlayer anions in the LDH.

3. The nanocomposite of claim 1, wherein the molar ratio of divalent cation to trivalent cation is 2:1.

4. The nanocomposite of claim 1, wherein the LDH, comprises:
(i) one divalent cation;
(ii) one trivalent cation; and,
(iii) first and second interlayer anions.

5. The nanocomposite of claim 4, wherein the molar ratio of divalent cation to trivalent cation is 2:1.

6. The nanocomposite of claim 1, wherein the graphene is selected from: graphene nano platelets (GNP), GNP-oxide (GNP-O), graphene oxide (GO), GNP-nitrogen (GNP-N₂), GNP-amine (GNP-NH₂), and GNP-silicon (GNP-Si).

7. The nanocomposite of claim 1, wherein:
the at least one divalent cation is selected from: Mg²⁺, Ni²⁺, Zn²⁺, Ca²⁺, Cu²⁺, and Mn²+;
the at least one trivalent cation is selected from: Al³⁺and Fe³⁺; and, the at least one interlayer anion is selected from: CO₃²⁻, SO₄²⁻, NO₃⁻, and Cr.

8. The nanocomposite of claim 1, wherein the divalent and trivalent cations are Mg²⁺ and Al³⁺, respectively.

9. The nanocomposite of claim 1, wherein the divalent and trivalent cations are Ca²⁺ and Al³⁺, respectively.

10. The nanocomposite of claim 1, wherein the divalent and trivalent cations are Mg²⁺ and Fe³⁺, respectively.

11. The nanocomposite of claim 1, wherein the interlayer anion is selected from: CO₃²⁻ and NO₃.

12. The nanocomposite of claim 1, wherein there are two interlayer anions, which are CO₃² and NO₃⁻.

13. The nanocomposite of claim 1, wherein the nanocomposite is selected from A-X:

| | | Divalent | Trivalent |
|---|---|---|---|
| G-LDH # | Graphene | Cation | Cation |
| A. | GNP | Mg²⁺ | Al³⁺ |
| B. | GNP | Ca²⁺ | Al³⁺ |
| C. | GNP | Mg²⁺ | Fe³⁺ |
| D. | GNP | Mn²⁺ | Fe³⁺ |
| E. | GNP-O | Mg²⁺ | Al³⁺ |
| F. | GNP-O | Ca²⁺ | Al³⁺ |
| G. | GNP-O | Mg²⁺ | Fe³⁺ |
| H. | GNP-O | Mn²⁺ | Fe³⁺ |
| I. | GO | Mg²⁺ | Al³⁺ |
| J. | GO | Ca²⁺ | Al³⁺ |
| K. | GO | Mg²⁺ | Fe³⁺ |
| L. | GO | Mn²⁺ | Fe³⁺ |
| M. | GNP-N₂ | Mg²⁺ | Al³⁺ |
| N. | GNP-N₂ | Ca²⁺ | Al³⁺ |
| O. | GNP-N₂ | Mg²⁺ | Fe³⁺ |
| P. | GNP-N₂ | Mn²⁺ | Fe³⁺ |
| Q. | GNP-NH₂ | Mg²⁺ | Al³⁺ |
| R. | GNP-NH₂ | Ca²⁺ | Al³⁺ |
| S. | GNP-NH₂ | Mg²⁺ | Fe³⁺ |
| T. | GNP-NH₂ | Mn²⁺ | Fe³⁺ |
| U. | GNP-Si | Mg²⁺ | Al³⁺ |
| V. | GNP-Si | Ca²⁺ | Al³⁺ |
| W. | GNP-Si | Mg²⁺ | Fe³⁺ |
| X. | GNP-Si | Mn²⁺ | Fe³⁺ |

wherein the molar ratio of divalent cation to trivalent cation is 2:1.

14. The nanocomposite of claim 1, wherein the molar ratio of divalent cation to trivalent cation is 2:1 and the weight (mg)/mmol ratio of graphene to divalent cation is about 3.5 to 214.

15. The nanocomposite of claim 1, wherein the molar ratio of divalent cation to trivalent cation is 2:1 and the weight (mg)/mmol ratio of graphene to divalent cation is selected from: (a) 3.5 to 179, (b) 7.1 to 143, (c) 8.9 to 107, and (d) 8.9 to 71.4.

16. A process of preparing a graphene containing layered double hydroxide (G-LDH), comprising:
(a) mixing an aqueous LDH-containing solution and graphene; and,
(b) sonicating the resulting mixture to form a G-LDH;
wherein the LDH, comprises: (i) at least one divalent cation, (ii) at least one trivalent cation, and at least one interlayer anion and the molar ratio of divalent to trivalent cation is 2:1.

17. A graphene containing nanocomposite, comprising:
(a) graphene; and,
(b) TiO₂;
wherein the graphene and TiO₂ form a graphene-TiO₂ nanocomposite (G-TiO₂).

18. The nanocomposite of claim 17, wherein the weight (mg)/mmol ratio of graphene to Ti is about 0.6 to 35.5.

19. The nanocomposite of claim 17, wherein the weight (mg)/mmol ratio of graphene to Ti is selected from: (a) about 0.6 to 29.6, (b) about 1.2 to 23.7, (c) about 1.5 to 17.8, and (d) about 1.5 to 11.8.

20. The nanocomposite of claim 17, wherein the graphene is selected from: graphene nano platelets (GNP), GNP-oxide (GNP-O), graphene oxide (GO), GNP-nitrogen (GNP-N₂), GNP-amine (GNP-NH₂), and GNP-silicon (GNP-Si).
